(19) United States
(12) Patent Application Publication
(10) Pub. No.: US 2025/0052526 A1
(43) Pub. Date: Feb. 13, 2025

(54) ADDITIVE MANUFACTURING OF PHASE CHANGE MATERIALS AND PHOTOCURABLE RESIN

(71) Applicant: Embry-Riddle Aeronautical University, Inc., Daytona Beach, FL (US)

(72) Inventors: Sandra Kathleen Sparr Boetcher, New Smyrna Beach, FL (US); Thomas Benjamin Freeman, Denver, CO (US); Casey Josh Troxler, Edgewater, MD (US); Rafael M. Rodriguez, Ormond Beach, FL (US); Isabel Melendez, San Juan, PR (US); Karl Benjamin Morgan, Audubon, NJ (US)

(21) Appl. No.: 18/799,603

(22) Filed: Aug. 9, 2024

Related U.S. Application Data
(60) Provisional application No. 63/518,521, filed on Aug. 9, 2023.

(51) Int. Cl. F28F 21/06; B33Y 80/00; C09K 5/06

(52) U.S. Cl. CPC F28F 21/067; C09K 5/06; B33Y 80/00; F28F 2255/16

(57) ABSTRACT

A thermal energy storage heat exchanger comprising can include a core defining a plurality of airflow passages to receive an airstream therethrough, the core can include microencapsulated phase change material suspended in a photocurable resin. The phase change material can be configured to change phases to store energy from and deliver stored energy to the airstream when the airflow passes through the core.

### STATEMENT REGARDING FEDERALLY SPONSORED RESEARCH OR DEVELOPMENT

This invention was made with government support under award number IBUILD Fellowship Program awarded by Building Technologies Office (BTO) administered by the Oak Ridge Institute for Science and Education (ORISE) and managed by Oak Ridge National Laboratory (ORNL) for the U.S. Department of Energy (DOE) and by grant no. MRI-1337742 for the purchase of the SEM awarded by National Science Foundation (NSF). The government has certain rights in this invention.

### CLAIM OF PRIORITY

This patent application claims the benefit of priority, under 35 U.S.C. Section 119 (e), to Boetcher et. al., U.S. patent application Ser. No. 18/480,746, entitled “ADDITIVE MANUFACTURING OF PHASE CHANGE MATERIALS AND PHOTOCURABLE RESIN,” filed on Oct. 4, 2023, (Attorney Docket No. 4568.018PRV) which is hereby incorporated by reference herein in its entirety.

### BACKGROUND

Phase change materials (PCMs) are materials that can change phases, such as between a liquid and a solid, and are able to store or expend latent heat in the process. PCMs such as hydrocarbons can be useful for energy storage for heating or cooling applications, such as in heating ventilation and air conditioning (HVAC). For example, PCMs are often positioned in containment devices to interact with a heat exchange medium (such as water, air, or refrigerant) when the medium flows through the containment device.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic view showing a mixture manufacturing method.

FIG. 2 illustrates a schematic view showing a printing configuration.

FIG. 3 illustrates a chart showing heat flow versus temperature of a microencapsulated phase-change material (MEPCM) suspended in a resin matrix.

FIG. 4 illustrates a perspective view of a latent heat of fusion testing arrangement.

FIG. 5 illustrates a chart showing heat flow versus temperature of a MEPCM suspended in a resin matrix.

FIG. 6 illustrates a perspective view of a thermal conductivity testing arrangement.

FIG. 7 illustrates a chart showing thermal conductivity versus MEPCM weight of a MEPCM suspended in a resin matrix.

FIG. 8 illustrates an enlarged cross-sectional view of a resin-MEPCM mixture sample.

FIG. 9A illustrates an enlarged perspective view of a surface of resin post-processing.

FIG. 9B illustrates an enlarged perspective view of a resin-MEPCM mixture sample post-processing.

FIG. 10 illustrates a product of a manufacturing process.

FIG. 11 illustrates a product of a manufacturing process.

FIG. 12 illustrates a perspective view of a portion of a heat exchanger.

FIG. 13 illustrates a product of a manufacturing process.

### DETAILED DESCRIPTION

PCMs are useful for exchanging energy or heat and have been used in many heat exchanger and energy storage applications. For example, PCMs can be used to store energy during off-peak electrical times for use in comfort cooling. PCMs can also be used within heat exchangers for HVAC or battery cooling. PCMs can also be used in building thermal management, perishables refrigeration, and biomedical applications. PCMs can absorb large amounts of energy in the form of heat as they undergo a phase change, remaining at a nearly constant temperature. PCMs have become increasingly popular in thermal energy storage systems due to their ability to remain at a near constant temperature while they absorb and release large amounts of heat during a solid-liquid phase change; however, these materials can require a shape-stabilizing agent or a containment technique that allows them to be used in thermal applications.

The devices and methods of this disclosure help to address these issues by directly suspending microencapsulated phase-change material (MEPCM) into photocurable resin for the purpose of additively manufacturing heat exchangers capable of storing latent heat for thermal energy storage applications. By using MEPCM, leaking can be limited while still taking advantage of the heat-transfer-enhancing benefits associated with polymer heat exchangers, such as their light weight, complex geometries, and non-fouling behavior. As PCMs undergo thermal cycling in their respective applications, a material continuously cycles between a solid and liquid phase. Using a microencapsulated form of PCM can mitigate this issue and can allow for higher PCM retention and improving system longevity.

Additive manufacturing can enhance the fabrication of PCM-based thermal energy storage (TES) systems by allowing for complex geometries that were previously unobtainable through traditional methods, such as injection molding and casting. The complex geometries can provide high surface-area-to-volume ratios, maximized PCM content, and thinner achievable walls, which can actively enhance the heat transfer performance of the system. The use of these techniques can also allow for the use of materials that were seen as unconventional for thermal applications in previous years. Contrary to their metal counterparts, polymer heat exchangers can be low in weight and cost, antifouling, and anticorrosive. Another advantage to polymers is that they can possess low melting points and can be processed at lower temperatures, meaning that they can be manufactured with less energy than metal heat exchangers. By introducing thinner walls or thermal-conductivity-enhancing additives, such as expanded graphite, graphene, carbon nanotubes, and ceramic fillers, some of the drawbacks to polymers, such as their low thermal conductivity, can be mitigated.

In TES applications, a PCM should have a high latent heat, a high thermal conductivity, chemical stability, a low cost, and be non-flammable. Organic materials can be a common type of PCM used in TES applications because of a wide range of transition temperatures and the chemical stability, thermal stability, and low toxicity, but can also be flammable and possess low thermal conductivity.

The present disclosure includes use of a liquid crystal display (LCD) printer to print functional composites with differing mass fractions of MEPCM and resin. The LCD printing methods discussed herein can provide lower-maintenance printing in shorter print times than other PCM-polymer printing techniques such as fused-filament-fabrication (FFF). The composites can be fabricated in short durations, using low-cost equipment and simple preparation methods. The enhanced geometrical features achievable through additive manufacturing can include a high surface-area-to-volume ratio, thin fins or walls, and uniform PCM suspension across the geometry.

Other additive manufacturing techniques for the printing of PCM composites can include fused-filament-fabrication (FFF), also referred to as fused filament deposition (FDM). FFF and FDM are filament-extrusion-based and can use a continuous filament of a thermoplastic material for printing. FFF and FDM are popular in the field due to a low cost involved with the materials and associated equipment, a wide array of material options, and an overall ability to scale. However, FFF and FDM can be difficult to achieve consistently because FFF and FDM typically involve fabricating a custom composite filament. Additionally, the elevated temperatures involved in the filament extrusion process can compromise the integrity of the encapsulation shells or result in low PCM retention during fabrication. Filament-dependent techniques can usually result in large air gaps in the three-dimensional (3D) printed parts, which can increase the thermal resistance that is found between the print layers and can decrease the effective thermal conductivity of the component.

Other additive manufacturing techniques for the printing of PCM composites can include direct-ink-writing (DIW), which relies on the depositing of an ink through a layer-by-layer extrusion similar to that of FDM or FFF. Other resin-based processes such as stereolithography (SLA), direct light projection (DLP), can also be used to fabricate PCM-based structures. These manufacturing processes can expose a layer of photocurable resin to an ultraviolet (UV) light source or laser. The resultant 3D printed geometries can have an improved resolution in shorter time frames compared to other techniques.

Custom PCM composite filaments can be created using high-density polyethylene for 3D printing using FFF. The thermal properties of the resulting composite can include 40% PCM42 by mass, which can be analyzed to determine the TES capability and thermal conductivity using differential scanning calorimetry (DSC) and transient plane source (TPS), respectively. The composite can have an effective PCM content corresponding to 31.8%, indicating that there can be significant PCM loss during production. This loss can be limited by using MEPCM (micro-encapsulated phase change material). A content of 40% MEPCM by mass can be optimal for printing while maximizing the effects of the PCM, such as by limiting loss of MEPCM reflected as degradation of the latent heat of fusion for a duration of over 50 DSC cycles, alluding to the successful containment of PCM during continuous thermal cycling.

MEPCM can be suspended in a photocurable resin for LCD 3D printing of composites possessing the capability of TES. The composites can be fabricated in short durations, using low-cost equipment and simple preparation methods. The addition of MEPCM to resin can result in a general increase in thermal conductivity when compared to that of pure resin. With the use of encapsulated materials, leaking and PCM retention issues can be greatly reduced. Furthermore, by suspending the MEPCM in photocurable resin, an additional method of containment or encapsulation can be achieved.

The above discussion is intended to provide an overview of subject matter of the present patent application. It is not intended to provide an exclusive or exhaustive explanation of the invention. The description below is included to provide further information about the present patent application.

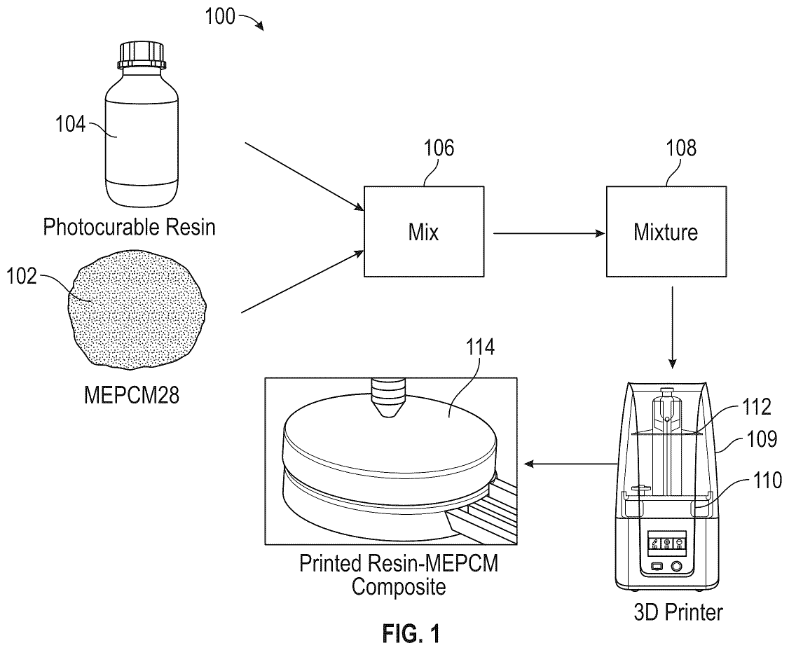

FIG. 1 illustrates a schematic view showing a mixture manufacturing method 100, in accordance with at least one example of this disclosure. The method 100 can be a method of manufacturing a resin-MEPCM composite disk 114. More specific examples of method 100 are discussed below. The steps or operations of the method 100 are illustrated in a particular order for convenience and clarity; many of the discussed operations can be performed in a different sequence or in parallel without materially impacting other operations. The method 100, as discussed, includes operations performed by multiple different actors, devices, and/or systems. It is understood that subsets of the operations discussed in the method 100 can be attributable to a single actor, device, or system and could be considered a separate standalone process or method.

At step 106, an MEPCM 102 and a resin 104 can be mixed to create a resin-MEPCM mixture 108. At step 110, the resin-MEPCM mixture 108 can be loaded to a resin printer 109. At step 112, the resin-MEPCM composite disk 114 can be printed using the resin printer 109. The resin-MEPCM composite disk can have a diameter of 10-50 mm, 10-30 mm, 30-50 mm, 20-40 mm, 25 mm-35 mm, or about 30 mm. The resin-MEPCM composite disk can have a thickness of 2-10 mm, 2-6 mm, 6-10 mm, 3-7 mm, or about 5 mm. The resin-MEPCM mixture 108 can have different mass ratios of MEPCM and resin, which can be used in the step 106 above. The method 100 can also include any of the steps discussed below.

TABLE 1
Mass ratios of MEPCM and resin

| | MEPCM | Resin |
|---|---|---|
| Sample | Content (%) | Content (%) |
| Resin | 0 | 100 |
| 10% | 10 | 90 |
| 20% | 20 | 80 |
| 30% | 30 | 70 |
| 35% | 35 | 65 |
| 37% | 37 | 63 |

As shown in Table 1 above, different mixtures of resin and MEPCM can be created by combining the two materials to form specific mass ratios, such as using the method discussed above. Mixing can be done manually with low intensities and speeds to prevent shell fractures as a result from stirring. Since varying the amount of MEPCM in the composite directly correlates to the TES capacity, a greater ratio of MEPCM within the composite can lead to a greater TES capacity; however, 3D printing methods that use photocurable resin as a printing medium can be particularly sensitive to variations in the resin properties such as its viscosity and depth of penetration. Introducing additives such as the MEPCM can alter the viscosity and depth of penetration, and thus can affect the resin curability and cause the printing process to fail. To determine an amount of MEPCM that can result in a resin suitable for LCD printing, the mass content can be increased in 10%, 5%, 2%, or 1% increments. A mixture of 37% MEPCM by mass can have a high PCM content that can also allow for consistent printed samples and consistent quality.

Mixtures with higher MEPCM contents can be prepared, but it can be found that increasing the MEPCM content, along with a corresponding increase in mixture viscosity, can directly correlate with the occurrence of an unsuccessful print. In some examples, the resin-MEPCM mixture 108 can be screened for consistency or viscosity prior to adding the resin-MEPCM mixture 108 into the resin printer 109.

In some examples, the resin 104 can be a photocurable resin, such as a High Tensile UV Photopolymer supplied by Photocentric (Avondale, AZ). The resin 104 can have a heat deflection temperature of 45-75° C., 50-70° C., 55-65° C., 60-70° C., or about 63° C., can have a density of 0.8-1.5 g/cm3, 0.9-1.2 g/cm3, 1.1-1.5 g/cm3, 1-1.2 g/cm3, or about 1.16 g/cm3, and can have a viscosity of 350-650 cPs, 400-550 cPs, 500-650 cPs, 475-525 cPs, or about 510 cPs. The MEPCM 102 can be raw or a pure phase change material, such as EnFinit PCM 28RPS-T supplied by Encapsys (Applton, WI). The MEPCM can be a paraffin wax, such as hexatriacontane, dotriacontane, triacontane, or any other paraffin wax PCM. The MEPCM can also be other types of PCM's, such as a non-paraffin organic, a hydrated salt, or a metallic PCM. The MEPCM can have a phase change temperature of 20-40° C., 25-35° C., 20-30° C., 25-30° C., or about 28° C.

In some examples, the resin 104 can be chosen from a diglycidyl ether of bisphenol F, a low epoxy equivalent weight diglycidyl ether of bisphenol A, a liquid epoxy novolac, a liquid aliphatic epoxy, a liquid cycloaliphatic epoxy, a 1,4-cyclohexandimethanoldiglycidylether, 3,4-epoxycyclohexylmethyl-3,4-epoxycyclohexane carboxylate, tetraglycidylmethylenedianiline, N,N,N′,N′-tetraglycidyl-4,4′-methylenebisbenzenamine, a triglycidyl of para-aminophenol, N,N,N′,N′-tetraglycidyl-m-xylenediamine, or a mixture thereof. In some examples, the acrylate resin can be chosen from a methacrylate, a methyl acrylate, a ethyl acrylate, a 2-chloroethyl vinyl ether, a 2-ethylhexyl acrylate, a hydroxyethyl methacrylate, a butyl acrylate, a butyl methacrylate, or a mixture thereof.

In some examples, the resin-MEPCM composite disk 114 can be sliced for printing by a slicing software, such as Chitubox software. The resin printer can be a desktop printer, such as an Elegoo Mars 3.

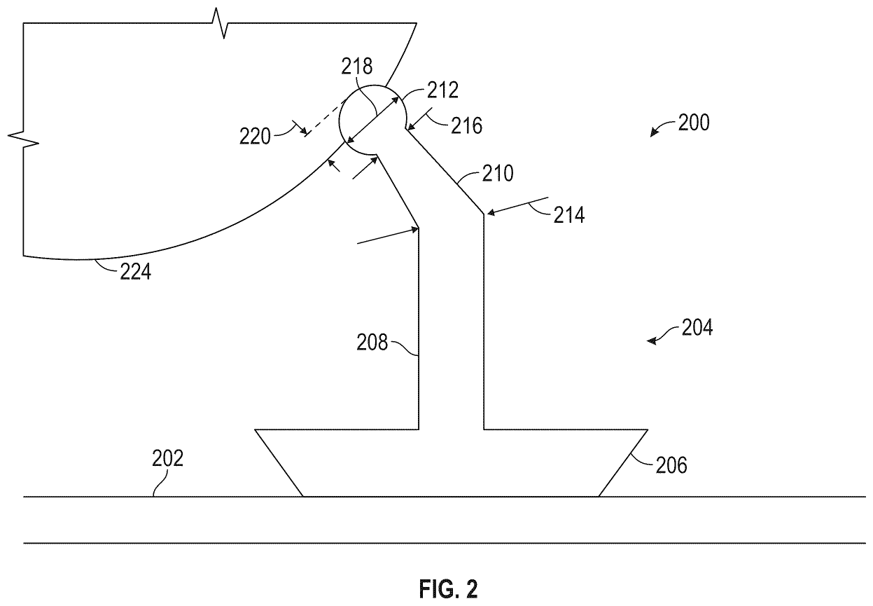

FIG. 2 illustrates a schematic view of a printing configuration 200. The printing configuration 200 can include a build plate 202, a support structure 204, and a sample 224. The support structure 204 can include a support structure base 206, a support structure shaft 208, a support structure neck 210, a support structure contact 212, a support structure shaft diameter 214, a support structure neck diameter 216, a support structure contact diameter 218, a support structure contact depth 220, and a sample 224.

The build plate 202 can be a sandblasted aluminum alloy and can act as a foundation for a printed structure. The support structure 204 can be a resin structure that can adhere to the build plate 202 and the sample 224. The support structure base 206 can be printed directly on the build plate 202. The support structure shaft 208 can be printed on the support structure base 206, can extend from the support structure base, and can have a support structure shaft diameter 214. The support structure neck 210 can be printed on the support structure shaft 208 and can have a support structure neck diameter 216. The neck 210 can extend from the shaft 208 at an angle, such as between 30 degrees and 60 degrees. The support structure contact 212 can be printed on the support structure shaft 208 and can have a support structure contact diameter 218. The support structure contact 212 can be spherical, round, or the like. The contact 212 can contact the sample 224 and the support structure contact 212 can support the sample 224. The support structure contact 212 can have a support structure contact diameter 218 and a support structure contact depth 220. The sample 224 can be a mixture of resin and MEPCM.

The support structure 204 can provide support to the sample 224 while printing unstable portions, such as an overhang, and can prevent the sample 224 from moving while the sample 224 is being printed. The build plate 202 can be a surface that the support structure base 206 can adhere to. The support structure base 206 can have a longer exposure time to help with adhesion to the build plate. The support structure shaft 208 can act as a lifting structure for the printing configuration 200. The support structure shaft 208 can also act as a support to prevent buckling from the sample 224 and can lift the sample 224 to prevent the printing of the sample 224 from being interrupted by the build plate 202. The support structure neck 210 can act as a junction between the sample 224 and the support structure shaft 208 and can reduce the area of contact between the sample 224 and the support structure 204. The support structure contact 212 can adhere directly to the sample 224 to attach the support structure 204 to the sample 224. The support structure shaft diameter 214 can be modified to increase the strength of the support structure 204. The support structure neck diameter 216 can also be modified to increase the strength of the support structure 204 and can be tapered to provide for a brittle point of contact between the sample 224 and the support structure 204 for easier removal of the support structure 204. The support structure contact diameter 218 can be adjusted to increase adhesion between the support structure contact 212 and the sample 224. The support structure contact depth 220 can be adjusted to increase the adhesion area between the support structure 204 and the sample 224. The sample 224 can be printed using the support structure 204, with different mixtures of resin and MEPCM altering the printing configuration 200 components.

Because the printing configuration 200 uses a relatively simple support structure 204, the printing configuration 200 can be used to provide an accessible method for printing a mixture of resin and MEPCM. The printing configuration 200 can also be used to print a mixture of resin and MEPCM with higher concentrations of MEPCM without the occurrence of an unsuccessful print.

The printing configuration 200 can use different print settings for different MEPCM and resin ratios.

TABLE 2
Print settings applied for different MEPCM/resin ratios

| Setting | Unit | 0% | 10% | 20% | 30% | 35% | 37% |
|---|---|---|---|---|---|---|---|
| Exposure time | S | 2.5 | 2.5 | 2.5 | 6 | 8 | 8 |
| Bottom exposure | S | 30 | 30 | 30 | 60 | 60 | 8 |
| Layer height | mm | 0.05 | 0.05 | 0.05 | 0.05 | 0.05 | 0.05 |
| Lift distance | mm | 5 | 5 | 5 | 10 | 10 | 10 |
| Lift speed | mm/min | 80 | 80 | 80 | 60 | 60 | 60 |
| Retract speed | mm/min | 210 | 210 | 210 | 210 | 150 | 150 |

As shown in Table 2 above, resin-MEPCM composite disks can be 3D printed with different print settings. When printing these mixtures, adhesion to the build plate can be challenging due to the increasing viscosity and altered resin properties. Print settings such as exposure time, lift speed, and bottom exposure time can be modified across the different mixtures to account for varying light penetration depth and viscosity. The support structure 204 can include different settings at the time of printing.

TABLE 3
Support settings applied to each sample
ratio at the time of printing.

| Setting | Unit | 0% | 10% | 20% | 30% | 35% | 37% |
|---|---|---|---|---|---|---|---|
| Contact diameter | mm | 0.80 | 0.80 | 2.00 | 2.00 | 2.00 | 2.20 |
| Upper diameter | mm | 0.40 | 0.40 | 1.00 | 1.00 | 1.00 | 1.00 |
| Lower diameter | mm | 1.20 | 1.20 | 1.50 | 1.50 | 1.50 | 1.50 |
| Contact depth | mm | 0.40 | 0.40 | 0.60 | 0.60 | 0.60 | 0.60 |

As shown in Table 3 above, different settings can be used for the support structure shaft diameter 214 (lower diameter), the support structure neck diameter 216 (upper diameter), the support structure contact diameter 218 (contact diameter), and the support structure contact depth 220 (contact depth). The supports applied to samples 20%, 30%, 35%, and 37% can feature increased contact diameter, upper diameter, lower diameter, and contact depth. The supports can be carefully removed post-printing, and the sample surface can be thoroughly cleaned using a solvent, such as isopropyl alcohol, methanol, acetone, or the like. The surface can then be wiped to remove any excess uncured resin. The samples can then be cured with a UV light for 30-210 minutes, 60-180 minutes, 75-135 minutes, 105-165 minutes, 90-150 minutes, 110-130 minutes, or about 120 minutes using a UV curing station, such as by using Form Cure by Formlabs (Sommerville, Massachusetts).

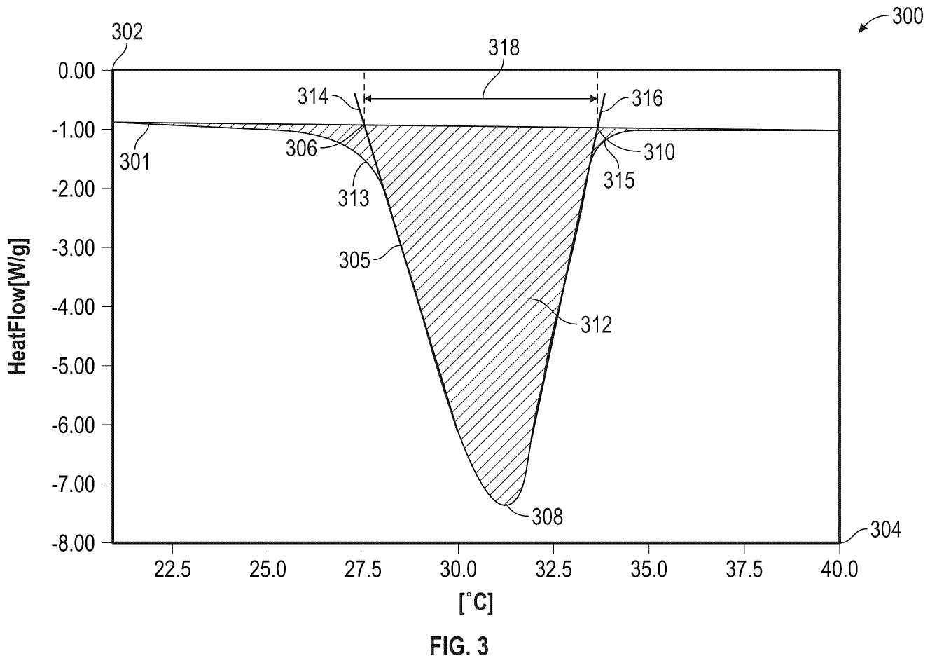

FIG. 3 illustrates an example DSC graph 300 showing heatflow versus temperature of MEPCM suspended in a resin matrix obtained from differential scanning calorimetry (DSC). The example DSC graph 300 can include a baseline 301, a first axis 302, a second axis 304, and a sample curve 305. The sample curve 305 can include an onset temperature 306, a peak temperature 308, an endset temperature 310, a sample curve area 312, a leading edge 313, a leading edge tangent line 314, a trailing edge 315, a trailing edge tangent line 316, and a melting range 318.

The baseline 301 can be a horizontal line on the example DSC graph 300. The first axis 302 can be one of the axis represented on the example DSC graph 300. The second axis 304 can also be one of the axis represented on the example DSC graph 300. The sample curve 305 can be the output produced by DSC for a sample 224. The onset temperature 306, peak temperature 308, endset temperature 310, sample curve area 312, and melting range 318 are each values that can be found by analyzing the sample curve 305. The leading edge 313 can be the first edge of the sample curve 305, and the trailing edge 315 can be the second edge of the sample curve 305. The leading edge tangent line 314 and the trailing edge tangent line 316 can be found by creating a line tangent to the leading edge 313 and the trailing edge 315 respectively.

The example DSC graph 300 can be produced by a differential scanning calorimeter, such as a DSC 3 STARe, from Mettler Toledo. The baseline 301 can be the signal produced when there are no thermal events occurring and can be used as a reference for comparison to the sample curve 305. The first axis 302 can represent heatflow in the example DSC graph 300 as a rate of heat transfer per unit mass and can be represented as watts per gram (W/g). The second axis 304 can represent the temperature and can be represented as degrees Celsius (C). The sample curve 305 can be produced by DSC. The onset temperature 306 can be the temperature at which the sample 224 begins melting, while the endset temperature 310 can be the temperature at which the sample stops melting. The onset temperature 306 can also be defined graphically as the intersection between the leading edge tangent lines 314 and the baseline 301, while the endset temperature 310 can be defined graphically as the intersection between the trailing edge tangent line 316 and the baseline 301. The peak temperature 308 can represent where, on the temperature axis, the heatflow peaks for the sample 224. The melting range 318 can be determined as the range between the onset temperature 306 and the endset temperature 310. The sample curve area 312 can be calculated as the area between the baseline 301 and the sample curve 305 and can represent the latent heat of fusion. By measuring the latent heat of fusion, the effective amount of MEPCM can be determined in the sample 224 through the ratio of the measured latent heat of fusion of the resin-MEPCM mixture and the measured latent heat of fusion of pure MEPCM.

In DSC, a sample with a mass of 7-30 mg, 10-25 mg, or 12-18 mg can be placed in an aluminum crucible with a volume of 20-160 μL, 25-120 μL, 30-100 μL, 35-80 μL, or about 40 μL. The sample mass can be measured using an analytical balance, such as an XS105DU from Mettler Toledo. The sample contained in the crucibles can be held at an initial temperature of 0° C. for a duration of 1-20 minutes, or 3-15 minutes, or 8-12 minutes, or about 10 minutes. Then, the temperature can be increased from 0° C. to 60° C. using a heating rate of 0.5-10° C./min, 1-8° C./min, 1.5-5° C./min, or about 2° C./min. The sample temperature of 60° C. can be maintained for 1-20 minutes, 3-18 minutes, 5-15 minutes, 8-12 minutes, or about 10 minutes before being cooled to 0° C. at 0.5-10° C./min, 1-8° C./min, 1.5-5° C./min, or about 2° C./min. Temperature and heatflow can be recorded every one second. These cycles can be performed a single time, or multiple times to help a sample melt and to facilitate thermal contact with the bottom of the crucible before measurement.

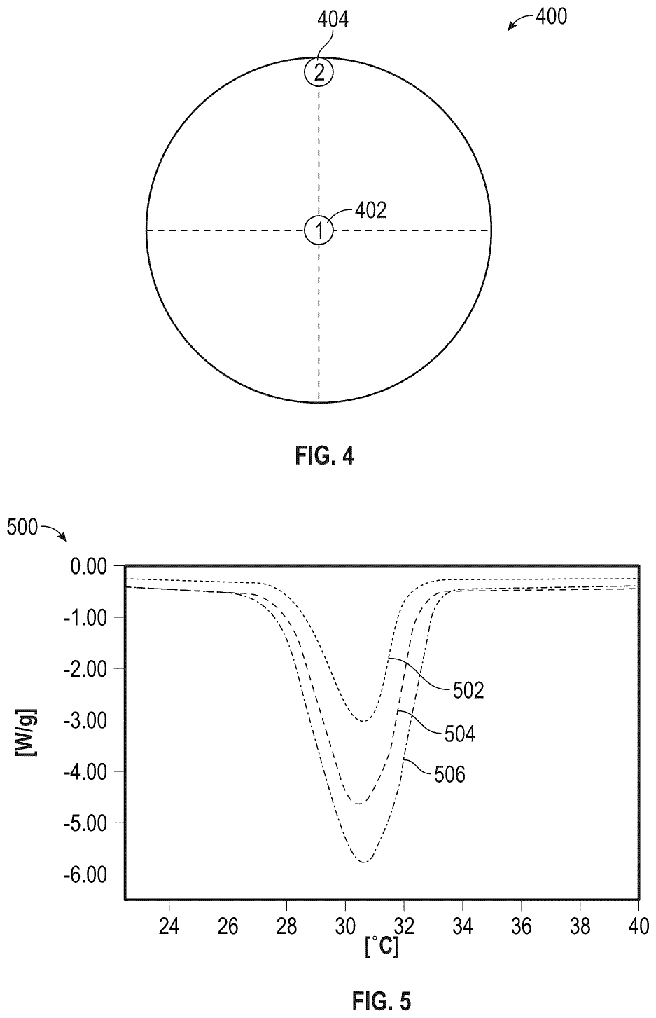

FIG. 4 illustrates a perspective view of a printed sample 400, with a first location 402 and a second location 404 marked. A sample can be taken from multiple different locations of a printed sample 400, such as the first location 402 and the second location 404, to be DSC-tested. By testing samples from multiple different locations, as shown in FIG. 4, it can be verified that the MEPCM is evenly distributed across the printed samples.

Samples can be collected from the two regions illustrated in FIG. 4 to verify the general material distribution as a result of the mixture preparation and printing process. Throughout the sample preparation process, it can be observed that the viscosity of the prepared MEPCM-resin mixture can allow for consistent suspension of the MEPCM even after periods of minimal mixing. It can be found that there is less than 1% latent heat of fusion variance across the tested samples, suggesting a uniform material distribution across the radius of the samples.

FIG. 5 illustrates a sample DSC graph 500 showing heatflow versus temperature of MEPCM suspended in a resin matrix obtained from DSC. The sample graph can include a sample curve for a first mixture 502, a second mixture 504, and a third mixture 506.

The first mixture 502 can have a mixture MEPCM percentage of 10%. The second mixture 504 can have a mixture MEPCM percentage of 20%. The third mixture 506 can have a mixture MEPCM percentage of 30%. The different mixture MEPCM percentages can be analyzed to determine trends between values, such as the peak temperature, onset temperature, endset temperature, and latent heat of fusion.

The sample DSC graph 500 can be used to find the peak temperature, onset temperature, endset temperature, latent heat of fusion, and effective amount of MEPCM for the different resin-MEPCM mixtures from their respective sample curves.

FIG. 5 can display that a higher MEPCM percentages can provide a higher latent heat of fusion. A higher latent heat of fusion can reduce the size of a heat exchanger and can also increase the efficiency of the heat exchanger.

TABLE 4
Phase-change temperature and latent heat of fusion
for differing samples of MEPCM-Resin material.

| Mixture MEPCM | Tpeak | Tonset | Tendset | hsl | Effective |
|---|---|---|---|---|---|
| Percentage | (° C.) | (° C.) | (° C.) | (kJ/kg) | PCM % |
| MEPCM | 30.13 | 27.59 | 34.80 | 143.54 | — |
| 10% | 30.55 | 28.11 | 32.02 | 12.79 | 8.91 |
| 20% | 30.34 | 27.93 | 32.48 | 22.93 | 15.97 |
| 30% | 30.47 | 27.67 | 33.00 | 36.06 | 25.12 |
| 35% | 30.96 | 27.69 | 33.41 | 39.87 | 27.78 |
| 37% | 30.75 | 27.61 | 33.53 | 46.60 | 32.47 |

As shown in Table 4 above, the peak temperature (Tpeak), onset temperature (Tonset), endset temperature (Tendset), latent heat of fusion (hsl), and effective amount of MEPCM (Effective PCM %) can be determined for different resin-MEPCM mixtures from their respective sample curves. It can be shown that as the mixture MEPCM percentage increases, the peak temperature, the onset temperature, and the endset temperature remain similar. It can be shown that the samples have an average peak melting temperature of 30.61° C., an average onset temperature of 27.80° C., and an average endset temperature of 32.89° C.

It can be shown that the latent heat of fusion is generally proportional to the amount of resin in the sample. It can be shown that as the MEPCM content doubles from 10% to 20%, the latent heat of fusion can increase by a factor of 1.79. It can also be shown that as the MEPCM content triples from 10% to 30%, the latent heat of fusion can increase by a factor of 2.81. The factors can suggest an unaccounted loss, which can be attributed to ruptured encapsulation shells that occur during the mixture manufacturing method 100, chemical interactions between materials and solvents used in rinsing, or a combination of both.

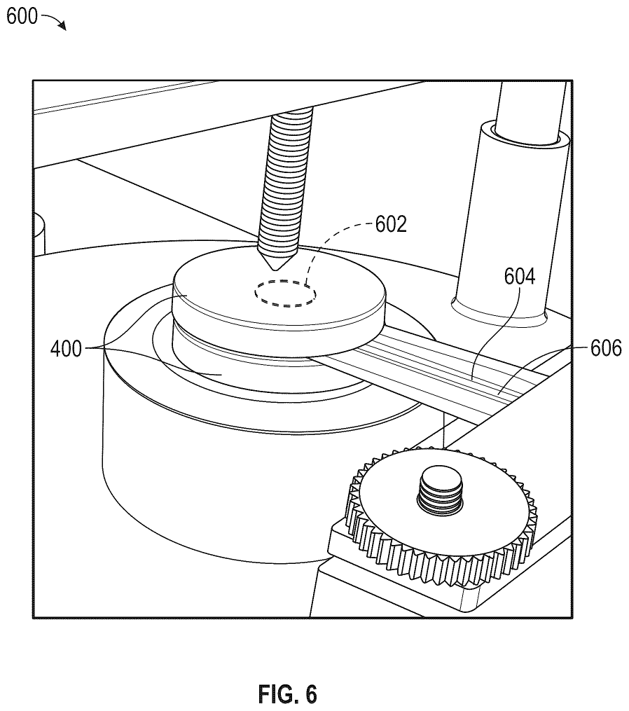

FIG. 6 illustrates a perspective view of a thermal content analyzer configuration 600. The thermal content analyzer configuration 600 can include a pair of printed samples 400, and a Kapton sensor 602. The Kapton sensor 602 can include a temperature sensor 604, and a resistance heater 606.

The printed samples 400 can be manufactured through the process outlined in FIG. 1. The Kapton sensor 602 can have a 4-mm diameter and can be a C7577 by Hot Disk (Gothenburg, Sweden). The Kapton sensor 602 can be sandwiched between a pair of printed samples 400, creating contact between the printed samples 400 and both the temperature sensor 604 and the resistance heater 606.

The resistance heater 606 can apply joule heating to the printed samples 400. The temperature response of the temperature sensor 604 can then be measured to determine the thermal conductivity of the samples through a mathematical model. A thermal constants analyzer, such as a Transient Plane Source 2500S by Hot Disk (Gothenburg, Sweden) can take the thermal conductivity measurements. A power of 5 mW and a sampling time of 10 seconds can be used during testing.

LCD printing can have a lack of air gaps, which can result in identical thermal conductivity of a bulk material compared to that of a 3D printed sample that is solid in geometry. LCD printing can produce smooth surfaces, which can be ideal for transient plane source testing because it can ensure good thermal contact with the resistance heater 606 as shown in FIG. 6. Poor contact with the resistance heater 606 can result in a lower measured thermal conductivity, which can skew results.

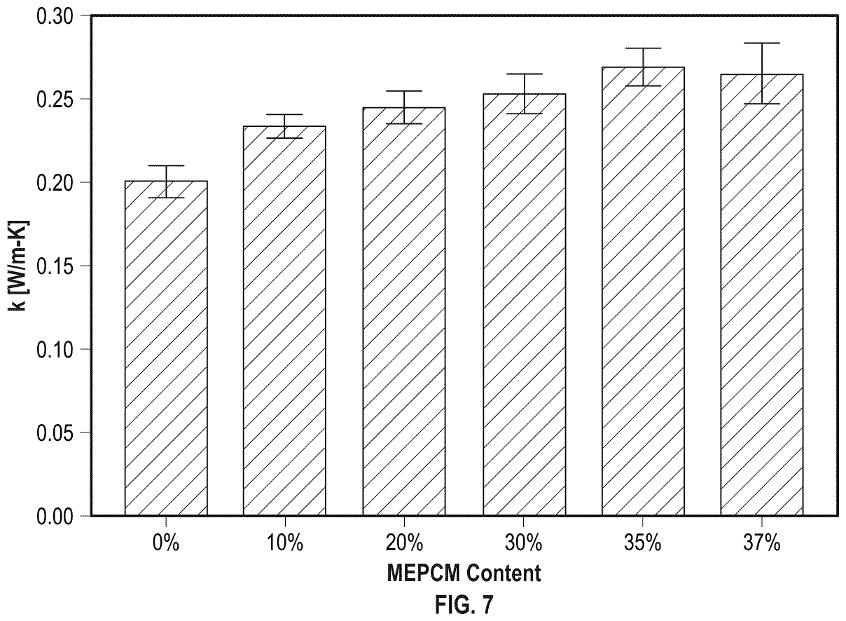

FIG. 7 illustrates a graph of thermal conductivity for samples with different MEPCM content. FIG. 7 can include error bars to represent standard deviation.

The samples can be measured in accordance with the thermal content analyzer configuration 600 in FIG. 6. A sample can be measured 1-50 times, 2-20 times, 5-15 times, 8-12 times, or about 10 times to determine an average effective thermal conductivity (k) and standard deviation (St. D) for the different MEPCM/resin mixture ratios. The resulting thermal conductivity measurements can be documented.

TABLE 5
Average thermal conductivity and standard deviation
for the different MEPCM/resin mixture ratios.

| Mixture MEPCM | k | St. |
|---|---|---|
| Percentage | [W/(m − K)] | D |
| Resin | 0.200 | 0.010 |
| 10% | 0.234 | 0.007 |
| 20% | 0.245 | 0.010 |
| 30% | 0.253 | 0.012 |
| 35% | 0.269 | 0.010 |
| 37% | 0.265 | 0.018 |

As shown in Table 5, it can be seen that the addition of MEPCM can result in an increase in thermal conductivity. It can be shown that pure resin can have an average thermal conductivity of 0.200 W/m-K, while an MEPCM content of 10% has an average thermal conductivity of 0.234 W/m-k. The mixture containing an MEPCM content of 37% can have an average thermal conductivity of 0.2655 W/m-K. The thermal conductivity can be further improved by using conductivity-enhancing additives and adjusting the geometry of the mixture. Heat transfer performance can be improved with thinner design walls and high surface-area-to-volume ratios.

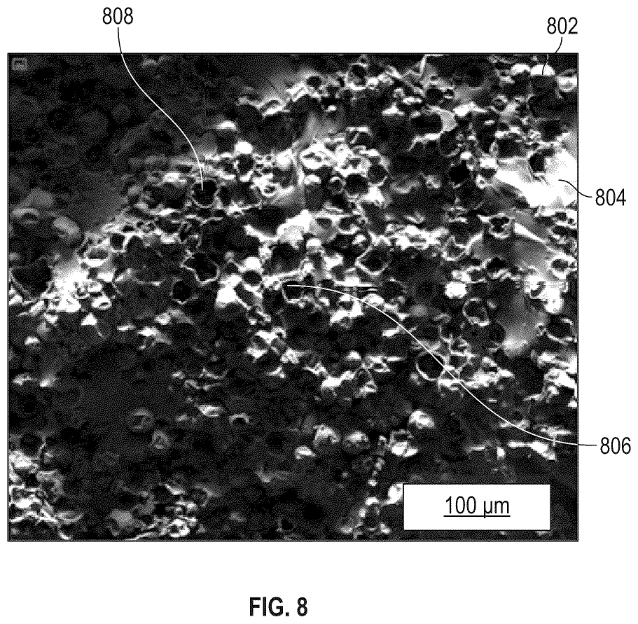

FIG. 8 illustrates an enlarged cross-sectional view of a resin-MEPCM mixture sample. The microstructures of the differing sample ratios can be observed using a scanning electron microscope, such as the Quanta 650 from ThermoFisher (Hillsboro, Oregon). The surface and cross-sectional topography of the samples can be visualized, which can verify the homogeneity of the composite as well as the structural integrity of the capsules post-printing and post-curing. An accelerating voltage of 1-10 kV, 3-8 kV, or about 5 kV can be used. A vacuum pressure between 0.75 and 4.5×10 (−6) Torr, 1.25 and 4×10(−6) Torr, or 1.75 and 3.50×10(−6) Torr can be used. A thin gold coating can be applied using a gold sputter, such as a Sputter Coater 108 from Cressington Scientific Instruments (Watford, United Kingdom), to improve the conductivity of the samples and prevent surface charging.

The cross-sectional view can show a generally homogenous mixture, including a generally even distribution of MEPCM particle 802. The cross-sectional view can include areas lacking MEPCM particles 802, such as surface 804. The cross-sectional view can also include areas with a surplus of MEPCM particles 802, such as at MEPCM accumulation 806. The different distributions of MEPCM particles 802 can occur due to material clumping, poor mixing in the mixture manufacturing method 100, or a combination of the two. Some of the MEPCM particles 802 can be hollow, such as in hollow particle 808. The hollow particle 808 can form from rupturing during any of mixing in the mixture manufacturing method 100, printing in accordance with FIG. 2, or when fracturing the resin-MEPCM mixture to obtain the enlarged cross-sectional view. The hollow particle 808 can contribute to the MEPCM loss reflected in Table 2 and can result in leaking.

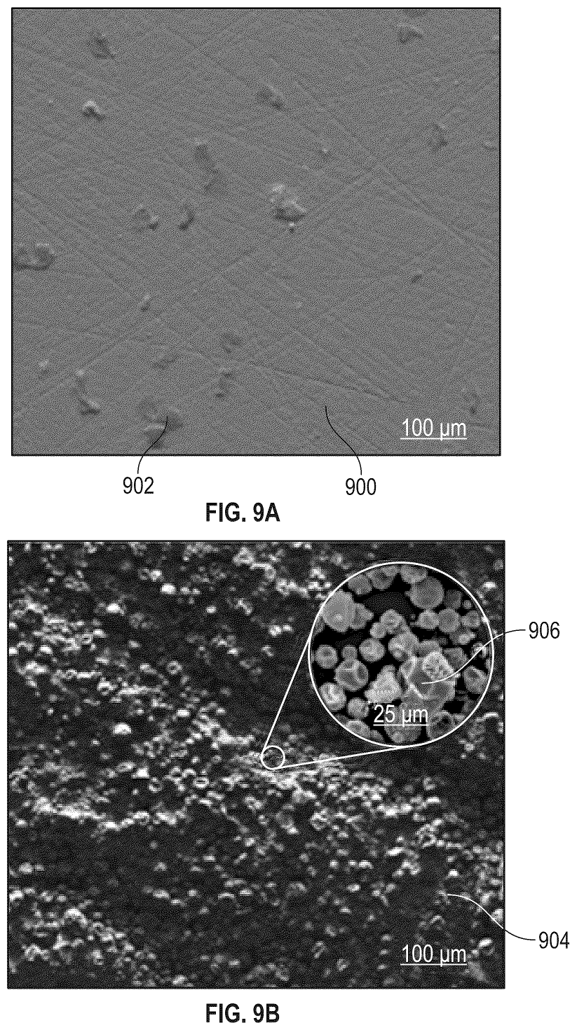

FIG. 8 shows an image that can be used to verify the general material distribution across the thickness of the samples post-fracture. FIG. 9A illustrates an enlarged perspective view of a surface of resin post-processing. FIG. 9B illustrates an enlarged perspective view of a 37% MEPCM content mixture sample post-processing. FIGS. 9A and 9B will be discussed together below.

As shown in FIGS. 9A and 9B, the addition of MEPCM to a pure resin sample can result in a surface finish that is less smooth than that of pure resin. The pure resin sample in FIG. 9A can have a primarily smooth resin surface finish 900, with minimal accumulations 902. The MEPCM-resin mixture in FIG. 9B, has a mixture surface finish 904 that can be less smooth from the MEPCM capsules 906.

The change in surface finish can be considered for applications involving an internal or an external flow where the walls are made of a MEPCM-resin composite mixture. A sample 224 can be sanded to result in a smoother surface, however sanding the surface can rupture the particles and can lead to additional hollow particles 808 as seen in FIG. 8. A sample 224 can follow a post processing cycle of a solvent bath, a wipe down, and UV curing, such as the process outlined in FIG. 2, which can result in non-ruptured capsules, such as the MEPCM capsules 906 in FIG. 9B.

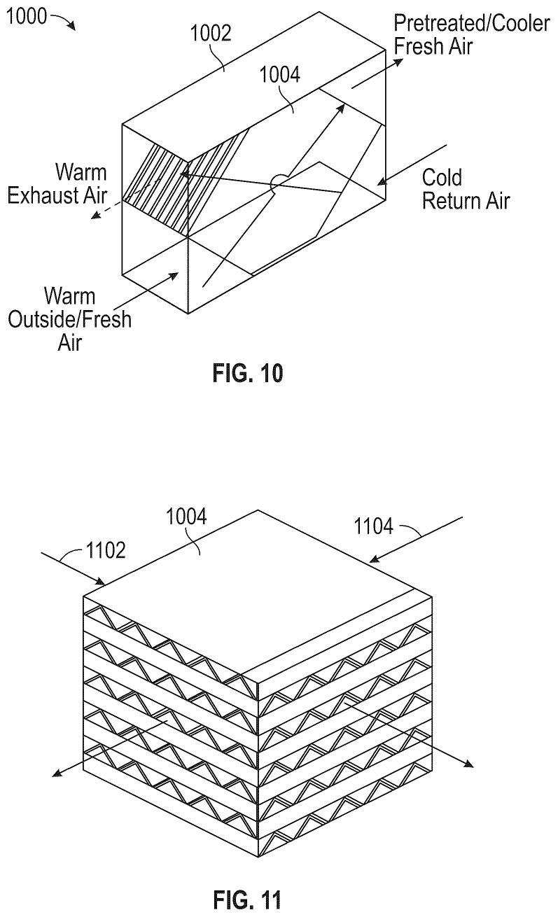

FIG. 10 illustrates a heat exchanger 1000 that can be formed, at least in part, including MEPCM that is manufactured using the manufacturing processes discussed above. The heat exchanger 1000 can include a housing 1002 and a core 1004. FIG. 11 shows the core 1004, a first fluid 1102, and a second fluid 1104. FIGS. 10 and 11 are discussed together below.

The heat exchanger 1000 or the core 1004 can be manufactured using the process discussed above (the core 1004 can be manufactured similar to the resin-MEPCM composite disk 114) and can use the resin printer 109 as a three-dimension printer to print a composite of the resin-MEPCM mixture 108 using the three-dimensional printer to form a three dimensional printed object. The core 1004 can be located at least partially within the housing 1002. The heat exchanger 1000 can be a cross-flow type heat exchanger often used for exchanging heat between an exhaust air stream (e.g., first fluid 1102) and an outdoor air or fresh air intake airstream (e.g., second fluid 1104). In operation, energy from the exhaust air stream can interact with the core 1004 to exchange energy with the core 1004 and the PCM therein.

The heat exchanger 1000 can be a thermal energy storage heat exchanger, and can comprise the housing 1002 and the core 1004. The core 1004 can be located at least partially within the housing 1002. The core 1004 can define a plurality of airflow passages to receive an airstream therethrough (e.g., a first fluid 1102). The core 1004 can comprise a composite of MEPCM (e.g., MEPCM 102 in FIG. 1) suspended in a photocurable resin (e.g., resin 104 in FIG. 1). The MEPCM 102 can be configured to change phases to store energy from, and deliver stored energy to, the airstream when airflow passes through the core 1004.

The composite of the core 1004 can optionally comprise at least thirty-five percent or thirty-seven percent MEPCM by mass. The composite of the core 1004 can optionally have an effective MEPCM mass content of at least thirty percent, as discussed relating to Table 4.

The photocurable resin 104 of the heat exchanger 1000 can optionally be a high-tensile ultraviolet photopolymer. The MEPCM 102 of the heat exchanger 1000 can optionally have a phase change temperature of between twenty-five and thirty-five degrees Celsius.

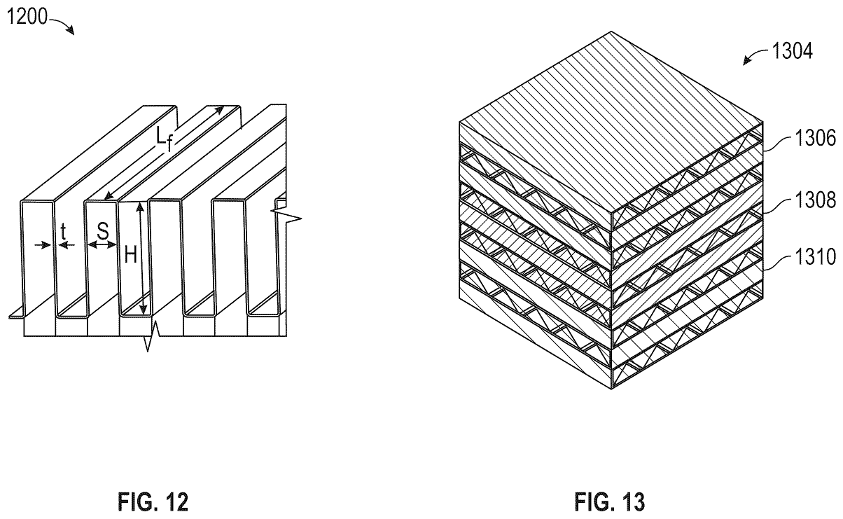

FIG. 12 illustrates a perspective view of a portion of layer of fins 1200 for a reference heat exchanger. The layer of fins 1200 can also be a fin, row of fins, or the like, where FIG. 12 shows a fin having or defining a fin thickness t, a fin height H, with fin spacing S, and fin length L.

FIG. 13 illustrates a heat exchanger core 1304 that can be produced using the manufacturing processes discussed herein. The heat exchanger core 1304 can include a first layer 1306, a second layer 1308, and a third layer 1310. Any of the layers can include a fin or row of fins similar to the fin of FIG. 12. The first layer 1306 can be made of a first composite fabricated from a first resin-MEPCM mixture. The second layer 1308 can be made of a second composite fabricated from a second resin-MEPCM mixture that is different than (e.g., a higher MEPCM content by mass) the first resin-MEPCM mixture. The third layer 1310 can be made of a third composite fabricated from a third resin-MEPCM mixture that is different than (e.g., a higher MEPCM content by mass) the first and second resin-MEPCM mixtures. For example, the first layer 1306 can be optimized for rapid thermal cycling (and can therefore have the lowest latent heat of fusion to use less energy to change phases), the third layer 1310 can be optimized as a thermal buffer (and can therefore have the highest latent heat of fusion to absorb excess heat), and the second layer 1308 can be optimized for rapid thermal cycling, as a thermal buffer, or a latent heat of fusion in between to perform sub-optimally but effectively in both rapid thermal cycling and as a thermal buffer.

### NOTES AND EXAMPLES

The following, non-limiting examples, detail certain aspects of the present subject matter to solve the challenges and provide the benefits discussed herein, among others.

Example 1 is a thermal energy storage heat exchanger comprising: a core defining a plurality of airflow passages to receive an airstream therethrough, the core comprising microencapsulated phase change material suspended in a photocurable resin, the phase change material configured to change phases to store energy from and deliver stored energy to the airstream when the airflow passes through the core.

In Example 2, the subject matter of Example 1 optionally includes wherein the composite of the core comprises at least thirty five percent phase change material by mass.

In Example 3, the subject matter of any one or more of Examples 1-2 optionally include wherein the photocurable resin is a high tensile ultraviolet photopolymer.

In Example 4, the subject matter of any one or more of Examples 1-3 optionally include wherein the phase change material has a phase change temperature of 28 degrees Celsius.

Example 5 is a heat exchanger as shown and described herein.

Example 6 is a method for fabricating a heat exchanger or heat exchanger core as shown and described herein.

Example 7 is a system for conditioning an airstream as shown and described herein.

Example 8 is a thermal energy storage method as shown and described herein.

Example 9 is a thermal energy storage heat exchanger comprising: a housing; a core located at least partially within the housing, the core defining a plurality of airflow passages to receive an airstream therethrough, the core comprising a composite of microencapsulated phase change material (MEPCM) suspended in a photocurable resin, the MEPCM configured to change phases to store energy from and deliver stored energy to the airstream when airflow passes through the core.

In Example 10, the subject matter of Example 9 optionally includes wherein the composite of the core comprises at least thirty-five percent MEPCM by mass.

In Example 11, the subject matter of any one or more of Examples 9-10 optionally include wherein the composite of the core comprises thirty-seven percent MEPCM by mass.

In Example 12, the subject matter of any one or more of Examples 9-11 optionally include wherein the photocurable resin is a high-tensile ultraviolet photopolymer.

In Example 13, the subject matter of any one or more of Examples 9-12 optionally include wherein the MEPCM has a phase change temperature of between twenty-five and thirty-five degrees Celsius.

In Example 14, the subject matter of any one or more of Examples 9-13 optionally include wherein the thermal energy storage heat exchanger is a cross-flow heat exchanger.

In Example 15, the subject matter of any one or more of Examples 9-14 optionally include wherein the composite has an effective MEPCM mass content of at least thirty percent.

Example 16 is a method for fabricating a heat exchanger or heat exchanger core, the method comprising: providing a polymer resin; providing a microencapsulated phase change material (MEPCM); mixing the polymer resin and the MEPCM to form a mixture of the polymer resin and the MEPCM; loading a mixture of the polymer resin and the MEPCM into a three-dimensional printer (3D printer); printing a composite of the mixture of the polymer resin and the MEPCM using the 3D printer to form a 3D printed object.

In Example 17, the subject matter of Example 16 optionally includes wherein the polymer resin is a photocurable resin.

In Example 18, the subject matter of Example 17 optionally includes wherein the photocurable resin is a high tensile ultraviolet photopolymer.

In Example 19, the subject matter of any one or more of Examples 17-18 optionally include wherein mixing the polymer resin and the MEPCM is performed at a speed where fracture of the MEPCM is limited.

In Example 20, the subject matter of any one or more of Examples 16-19 optionally include wherein the composite comprises at least thirty-five percent MEPCM by mass.

In Example 21, the subject matter of any one or more of Examples 16-20 optionally include wherein the composite comprises thirty-seven percent MEPCM by mass.

In Example 22, the subject matter of any one or more of Examples 16-21 optionally include wherein the composite has an effective MEPCM mass content of at least thirty percent.

In Example 23, the subject matter of any one or more of Examples 16-22 optionally include wherein the 3D printed object is a core of a heat exchanger.

In Example 24, the subject matter of any one or more of Examples 16-23 optionally include wherein the MEPCM has a phase change temperature of between twenty-five and thirty-five degrees Celsius.

Example 25 is a method for encapsulating a phase change material for use in thermal applications, the method comprising; providing a photocurable resin; providing a microencapsulated phase change material (MEPCM); providing a conductivity-enhancing additive; suspending the MEPCM and the conductivity-enhancing additive in the photocurable resin to form a suspension; loading the suspension into a three-dimensional printer (3D printer); printing, using the 3D printer, a 3D-printed object from the suspension.

In Example 26, the subject matter of Example 25 optionally includes loading a UV curing station with the 3D-printed object; curing, with the UV curing station, the 3D-printed object for a period of time between 90 minutes and 150 minutes.

In Example 27, the subject matter of any one or more of Examples 25-26 optionally include wherein the MEPCM has a phase change temperature of between twenty-five and thirty-five degrees Celsius.

In Example 28, the subject matter of any one or more of Examples 25-27 optionally include wherein the suspension has an effective MEPCM mass content of at least thirty percent.

In Example 29, the apparatuses or method of any one or any combination of Examples 1-28 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A thermal energy storage heat exchanger comprising:
a housing; and
a core located at least partially within the housing, the core defining a plurality of airflow passages to receive an airstream therethrough, the core comprising a composite of microencapsulated phase change material (MEPCM) suspended in a photocurable resin, the MEPCM configured to change phases to store energy from and deliver stored energy to the airstream when airflow passes through the core.

2. The thermal energy storage heat exchanger of claim 1, wherein the composite of the core comprises at least thirty-five percent MEPCM by mass.

3. The thermal energy storage heat exchanger of claim 1, wherein the composite of the core comprises thirty-seven percent MEPCM by mass.

4. The thermal energy storage heat exchanger of claim 1, wherein the photocurable resin is a high-tensile ultraviolet photopolymer.

5. The thermal energy storage heat exchanger of claim 1, wherein the MEPCM has a phase change temperature of between twenty-five and thirty-five degrees Celsius.

6. The thermal energy storage heat exchanger of claim 1, wherein the thermal energy storage heat exchanger is a cross-flow heat exchanger.

7. The thermal energy storage heat exchanger of claim 1, wherein the composite has an effective MEPCM mass content of at least thirty percent.

8. A method for fabricating a heat exchanger or heat exchanger core, the method comprising:
providing a polymer resin;
providing a microencapsulated phase change material (MEPCM);
mixing the polymer resin and the MEPCM to form a mixture of the polymer resin and the MEPCM;
loading a mixture of the polymer resin and the MEPCM into a three-dimensional printer (3D printer); and
printing a composite of the mixture of the polymer resin and the MEPCM using the 3D printer to form a 3D printed object.

9. The method of claim 8, wherein the polymer resin is a photocurable resin.

10. The method of claim 9, wherein the photocurable resin is a high tensile ultraviolet photopolymer.

11. The method of claim 9, wherein mixing the polymer resin and the MEPCM is performed at a speed where fracture of the MEPCM is limited.

12. The method of claim 8, wherein the composite comprises at least thirty-five percent MEPCM by mass.

13. The method of claim 8, wherein the composite comprises thirty-seven percent MEPCM by mass.

14. The method of claim 8, wherein the composite has an effective MEPCM mass content of at least thirty percent.

15. The method of claim 8, wherein the 3D printed object is a core of a heat exchanger.

16. The method of claim 8, wherein the MEPCM has a phase change temperature of between twenty-five and thirty-five degrees Celsius.

17. A method for encapsulating a phase change material for use in thermal applications, the method comprising;
providing a photocurable resin;
providing an additive, the additive including a microencapsulated phase change material (MEPCM);
suspending the additive in the photocurable resin to form a suspension;
loading the suspension into a three-dimensional printer (3D printer); and
printing, using the 3D printer, a 3D-printed object from the suspension.

18. The method of claim 17, further comprising:
loading a UV curing station with the 3D-printed object; and
curing, with the UV curing station, the 3D-printed object for a period of time between 90 minutes and 150 minutes.

19. The method of claim 17, wherein the additive further includes a conductivity enhancing additive.

20. The method of claim 17, wherein the suspension has an effective MEPCM mass content of at least thirty percent.
